(19) United States
(12) Patent Application Publication
(10) Pub. No.: US 2026/0312943 A1
(43) Pub. Date: Oct. 8, 2026

(54) BATTERY-LESS ENERGY HARVESTING TAG (ETAG) PAYLOAD DECRYPTION AT ELECTRONIC LABELS

(71) Applicant: QUALCOMM Incorporated, San Diego, CA (US)

(72) Inventors: Varun Amar REDDY, San Diego, CA (US); Amit GOEL, San Diego, CA (US); Sony AKKARAKARAN, Poway, CA (US); Michael MITRANI, San Diego, CA (US)

(21) Appl. No.: 19/536,757

(22) Filed: Feb. 11, 2026

Related U.S. Application Data
(60) Provisional application No. 63/783,393, filed on Apr. 4, 2025.

(51) Int. Cl. H04L 9/40; H04L 9/14

(52) U.S. Cl. CPC H04L 63/0428; H04L 9/14

(57) ABSTRACT

In some aspects, a method performed by an electronic label device includes receiving, from an energy harvesting tag, an encrypted payload; and transmitting, to a network component, (1) a decrypted payload generated by decrypting the encrypted payload or (2) the encrypted payload without decryption based on one or more criteria associated with determining whether to perform the decryption by the electronic label device.

### CROSS-REFERENCE TO RELATED APPLICATIONS

The present Application for Patent claims the benefit of U.S. Provisional Application No. 63/783,393, entitled “BATTERY-LESS ENERGY HARVESTING TAG (ETAG) PAYLOAD DECRYPTION AT ELECTRONIC LABELS,” filed Apr. 4, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic labels are an example of electronic label devices used by retailers for displaying product pricing or other product information to consumers. Electronic labels typically use electronic paper (e-paper) or liquid crystal display (LCD) to display the current information. E-paper (also referred to as e-ink) is widely used for electronic labels, as it provides a sharp display and supports full graphic imaging while only needing power during updates and no power to retain an image.

Electronic labels are increasingly being integrated with existing retail technologies, such as electronic article surveillance, digital signage, and people counters. For example, retailers can upload a floor plan of the sales area into the electronic label management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method performed by an electronic label device includes receiving, from an energy harvesting tag, an encrypted payload; and transmitting, to a network component, (1) a decrypted payload generated by decrypting the encrypted payload or (2) the encrypted payload without decryption based on one or more criteria associated with determining whether to perform the decryption by the electronic label device.

In some aspects, an electronic label device includes one or more memories; one or more transceivers; and one or more processors communicatively coupled to the one or more memories and the one or more transceivers, the one or more processors, either alone or in combination, configured to: receive, via the one or more transceivers, from an energy harvesting tag, an encrypted payload; and transmit, via the one or more transceivers, to a network component, (1) a decrypted payload generated by decrypting the encrypted payload or (2) the encrypted payload without decryption based on one or more criteria associated with determining whether to perform the decryption by the electronic label device.

In some aspects, an electronic label device includes means for receiving, from an energy harvesting tag, an encrypted payload; and means for transmitting, to a network component, (1) a decrypted payload generated by decrypting the encrypted payload or (2) the encrypted payload without decryption based on one or more criteria associated with determining whether to perform the decryption by the electronic label device.

In some aspects, a non-transitory computer-readable medium stores computer-executable instructions that, when executed by an electronic label device, cause the electronic label device to: receive, from an energy harvesting tag, an encrypted payload; and transmit, to a network component, (1) a decrypted payload generated by decrypting the encrypted payload or (2) the encrypted payload without decryption based on one or more criteria associated with determining whether to perform the decryption by the electronic label device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic label system, according to aspects of the disclosure.

FIG. 2 illustrates example components of an example electronic label, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example electronic label deployment scenario, according to aspects of the disclosure.

FIG. 5 is a diagram illustrating an example positioning scenario using a weighted centroid algorithm, according to aspects of the disclosure.

FIG. 6 illustrates an example electronic tag, according to aspects of the disclosure.

FIG. 7 illustrates an example BLUETOOTH® Low Energy (BLE) generic attribute profile (GATT) procedure, according to aspects of the disclosure.

FIG. 8 illustrates an example electronic label periodic advertising with responses (PAWR) scheme, according to aspects of the disclosure.

FIG. 9 illustrates example aspects of symmetric encryption, according to aspects of the disclosure.

FIG. 10 illustrates an example method of wireless payload decryption, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to energy harvesting tag (eTag) payload decryption. Some aspects more specifically relate to eTag payload decryption by an electronic label device such as an electronic label based on one or more criteria. In some examples, the electronic label device may receive, from an energy harvesting tag, an encrypted payload, and transmit, to a network component, (1) a decrypted payload generated by decrypting the encrypted payload or (2) the encrypted payload without decryption based on one or more criteria associated with determining whether to perform the decryption by the electronic label device.

Particular aspects of the subject matter described in this disclosure can be implemented to realize one or more of the following potential advantages. In some examples, by allowing the electronic label device to determine whether to decrypt an encrypted eTag payload or to relay the encrypted payload to the network component (e.g., AP) without decryption, the payload (encrypted or decrypted) may be transferred efficiently by balancing the tradeoffs between power consumption and complexity of decryption processing on the part of the electronic label device, based on factors such as the size of the encrypted payload, the distance between the electronic label and the AP, the computation or processing cost associated with decryption, energy storage at the electronic label, the priority of the eTag, and/or the priority of the payload.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic labels are an example of electronic label devices used by retailers for displaying product pricing or other product information to consumers. Electronic labels typically use electronic paper (e-paper) or liquid crystal display (LCD) to display the current information. E-paper (also referred to as e-ink) is widely used for electronic labels, as it provides a sharp display and supports full graphic imaging while only needing power during updates and no power to retain an image, thereby significantly reducing power consumption.

Electronic labels are increasingly being integrated with existing retail technologies, such as electronic article surveillance, digital signage, and people counters. For example, retailers can upload a floor plan of the sales area into the electronic label management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

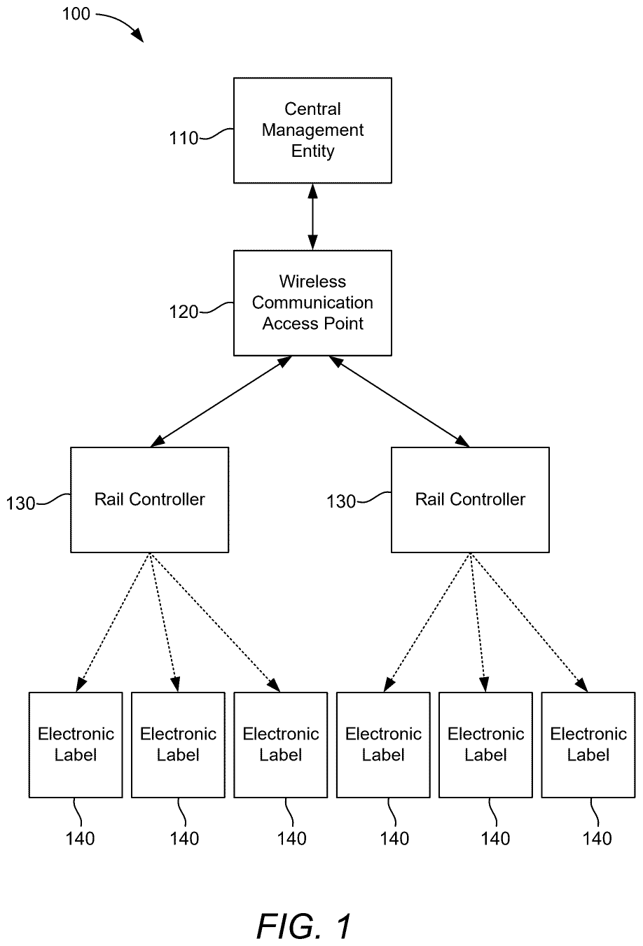

FIG. 1 illustrates an example electronic label system 100, according to aspects of the disclosure. An electronic label system generally includes three components: label management software (e.g., running on a central management entity 110, such as a local server at the retail location or a cloud-based server), one or more wireless communication access points 120 (e.g., Wi-Fi® access points), one or more rail controllers 130, and one or more (usually many) electronic labels 140. The label management software is responsible for the configuration of the system, configuration of the properties of the electronic labels 140 themselves, and storing the database of information to be displayed by the electronic labels 140. The software mainly covers the network management, file systems, and transmission of data. It also processes and packs the data to be displayed into packets of information. The data packets are then sent to one or more wireless communication access points 120 via a wireless network (e.g., Wi-Fi®) for distribution to the electronic labels 140 via the one or more rail controllers 130.

A wireless communication access point 120 is responsible for the stability and reliability of transmissions from the label management software (on the central management entity 110) to the electronic labels 140. There may be multiple wireless communication access points 120 deployed in a single retail location based on the size of the space and/or the number of electronic labels 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple electronic labels 140 can be “clipped” or otherwise attached. Once clipped to the rail, each electronic label 140 has a wired connection to the rail controller 130 (e.g., via a three-wire bus for power, ground, and data).

An electronic label 140 functions as a receiver from the wireless communication access point 120 (via the rail controller 130) to display the information configured from the label management software. The electronic label 140 then acts based on the instructions that were provided in the data packets from the label management software. An electronic label 140 includes a display and optionally a camera, electronic labels 140 generally do not include batteries, as they are typically powered by the rail to which they are attached. However, in some cases, an electronic label 140 may be powered by a coin-cell battery, which may provide an operational life of eight to nine years. In some cases, an electronic label 140 may not have a short-range wireless communications radio (e.g., a BLE radio), as it receives data from the wireless communication access point 120 via the wired rail connection to the rail controller 130.

An electronic label application programming interface (API) is included in the current BLUETOOTH® specification and permits a 7-bit group identifier of 8-bit unique electronic label identifiers, allowing for a total of 32,640 electronic labels 140 to be allocated for one wireless communication access point 120. With those constraints, multiple wireless communication access points 120 may be needed to cover a typical grocery store electronic label application.

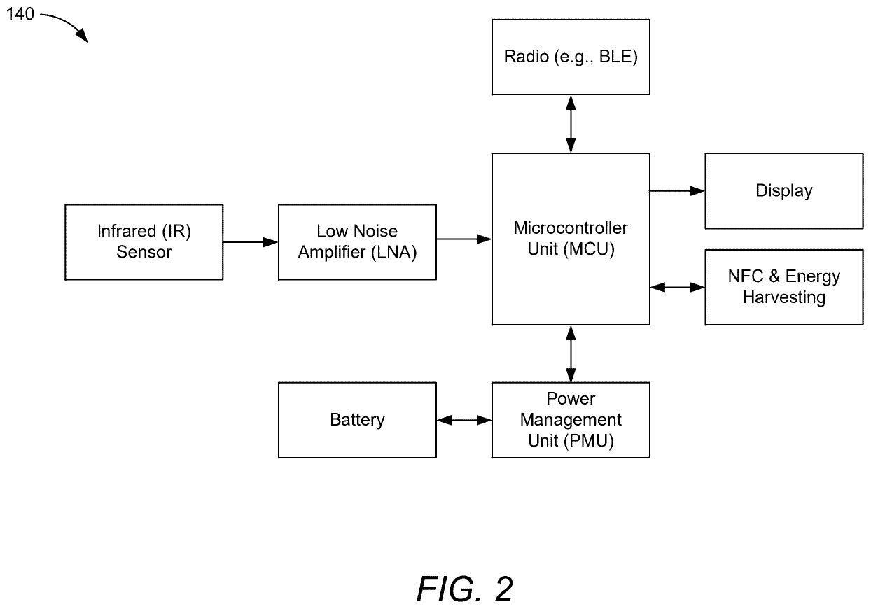

FIG. 2 illustrates example components of an example electronic label 140, according to aspects of the disclosure. Note that in some cases, rather than an electronic label 140 having its own wireless radio (e.g., a BLE radio) as shown in FIG. 2, multiple electronic labels 140 may be attached (e.g., clipped) to a rail attached to a retail shelf. In this case, the rail (specifically a rail controller 130) contains the short-range wireless communications radio and the electronic labels 140 have just the display. The radio controller 130 in the rail communicates locally to the clipped-on electronic labels 140 over a wired protocol (the act of clipping on connects the electronic labels 140 to the wires of the rail controller 130). As such, an electronic label 140 itself may not have a radio but may connect locally to one (i.e., the rail controller 130).

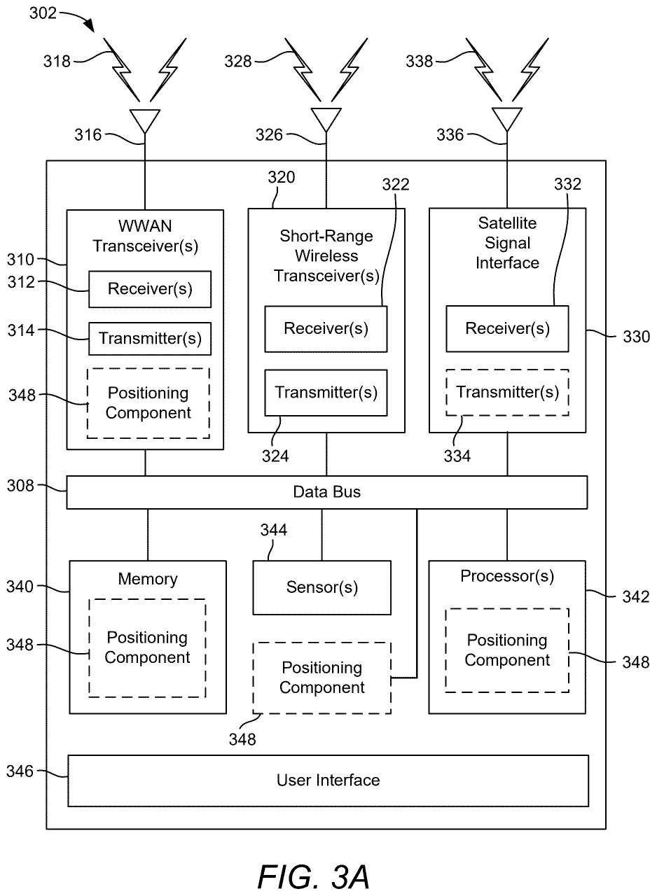

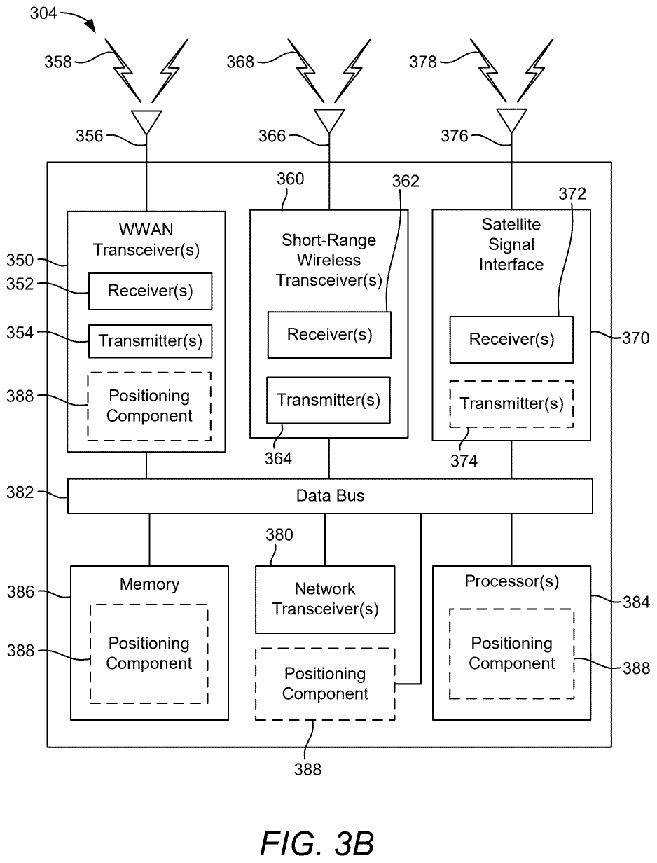

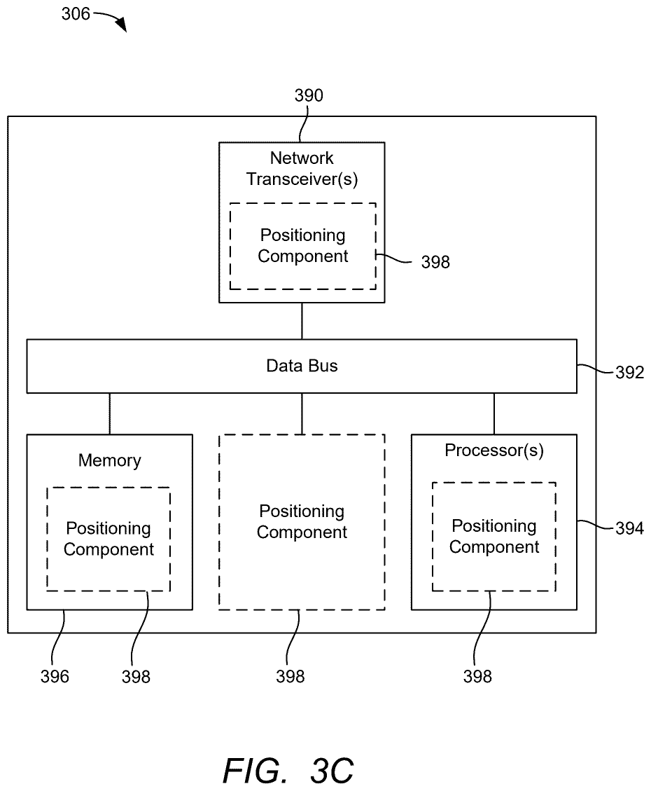

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi®, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi® transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 348, 388, and 398, respectively. The positioning component 348, 388, and 398 may be hardware circuits that are part of or coupled to the processors 342, 384, and 394, respectively, and are configured to cause the UE 302, the base station 304, and the network entity 306 to perform the functionality described herein. In other aspects, the positioning component 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi® and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi® “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi®).

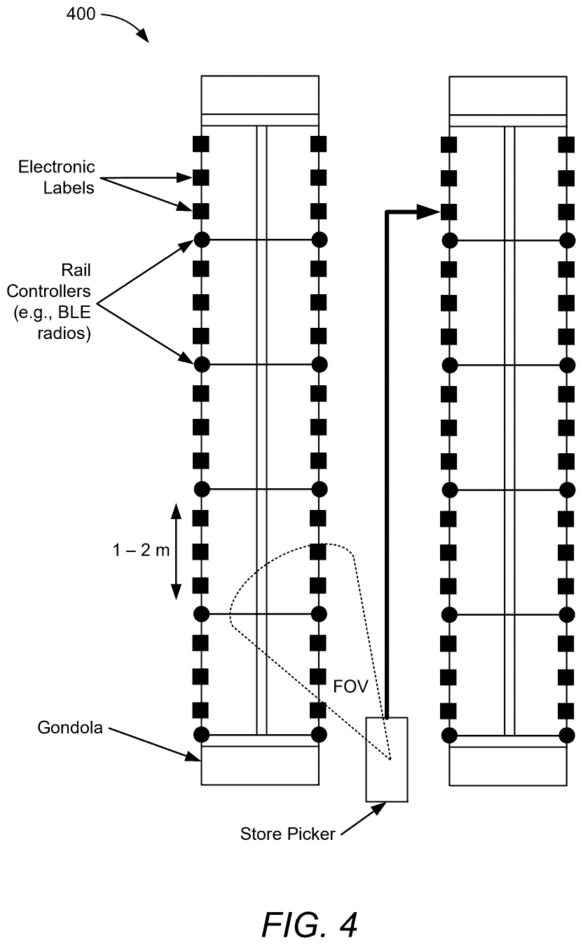

FIG. 4 is a diagram 400 illustrating an example electronic label deployment scenario, according to aspects of the disclosure. Specifically, FIG. 4 illustrates a top view of a scenario where electronic labels (e.g., electronic labels 140) are deployed on both sides of two aisles of shelves in a retail establishment, warehouse, or the like. In the example of FIG. 4, groups of three electronic labels are connected to a rail controller (e.g., a radio controller 130 utilizing, for example, a BLE radio) and the rail controllers are spaced 1 m to 2 m apart. However, as will be appreciated, this is merely an example configuration and there may be more or fewer electronic labels per rail controller spaced closer or further apart.

In some cases, the electronic labels may not be equipped with short-range wireless communications radios (e.g., BLE radios), and instead, the rail controller may include the short-range wireless communications radio for the three electronic labels connected to it. In either case, the radio associated with an electronic label (whether a component of the electronic label of the rail controller to which the electronic label is connected) may be referred to as an “electronic label radio.”

Indoor positioning based on BLE beaconing from electronic labels is being developed for retail and warehouse applications. In general, the location of a target device (e.g., an energy harvesting tag (eTag)) is determined based on signal strength measurements (e.g., received signal strength indicator (RSSI)) of beacon signals transmitted by multiple electronic labels. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

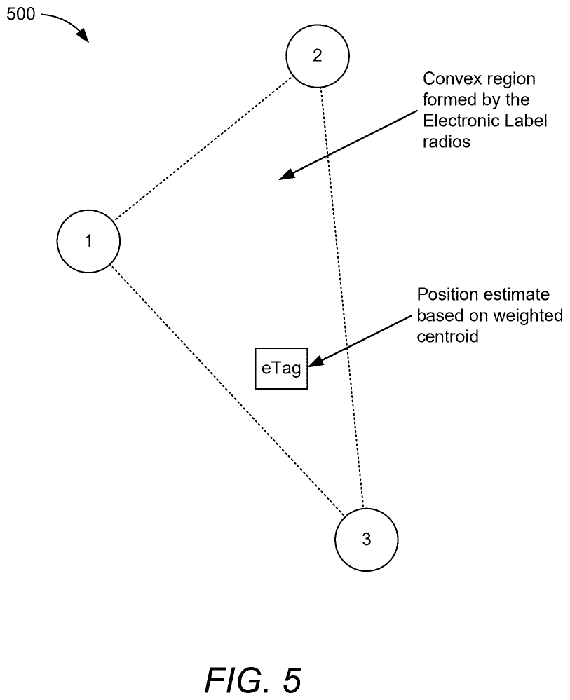

FIG. 5 is a diagram 500 illustrating an example positioning scenario using a weighted centroid algorithm, according to aspects of the disclosure. In the example of FIG. 5, measurements of the beacon signals transmitted by three electronic label radios (labeled “1,” “2,” and “3”) are used to determine a location of a target device (labeled “eTag”). For a given target device beacon transmission, let r₁≥r₂≥ . . . r_{M} denote the RSSI values of the beacon as measured by M electronic label radios (in descending order). The target device position estimate is then given by the weighted average of the electronic label radio positions, where the weights are a function of the RSSI values:

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of electronic label radios that are used in the computation, and wₖ is an exponential function (based on a value λ) of the RSSI values. N and λ are empirical terms that may be preset to some desired value. The weights may be proportional to the RSSIs. That is, the weight assigned to the k^{th} electronic label radio is proportional to the signal strength measured by that electronic label radio, meaning an electronic label radio associated with a higher RSSI may be assigned a larger weight. In the example of FIG. 5, w₃>w₁>w₂.

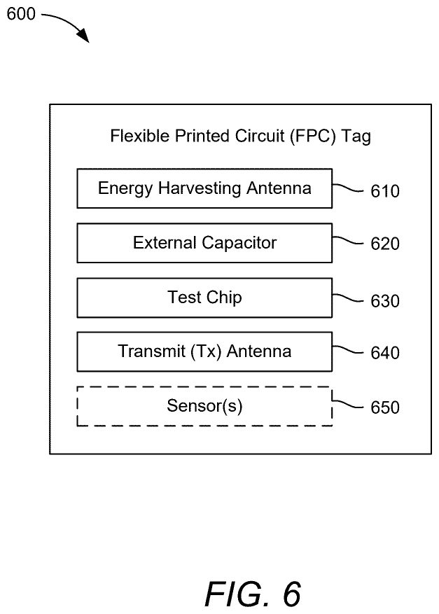

Low-cost battery-less energy harvesting “tags” (referred to as “eTags”) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi®, NR). For example, the test chip 630 and transmit antenna 640 may act as a BLE beacon and support BLE advertisement transmission. Note that in some cases, the transmit antenna 640 may also act as an energy harvesting antenna.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby electronic label radios. The electronic label radios may report their RSSI measurements to the central management entity 110, which may calculate the position of the eTag 600 or forward the measurements to another entity for processing.

An example wireless communication protocol that may be utilized to support electronic label-to-AP signaling is the BLE generic attribute profile (GATT) protocol. For example, electronic labels may contain a BLE GATT server, and scan result read characteristics can be defined for target device RSSI measurements (e.g., for the reporting of target RSSI measurements from electronic label(s) to the electronic label AP). Advantages of the BLE GATT protocol include support for bulk data read operations, allowing for accumulation and less frequent reads of target device scan results. This can be useful if there are many active target devices (e.g., battery-less energy harvesting tags (eTags)). A downside of the BLE GATT protocol is the overhead of the BLUETOOTH® asynchronous connection-oriented logical transport (ACL) connect/disconnect for every query, which results in slower response time.

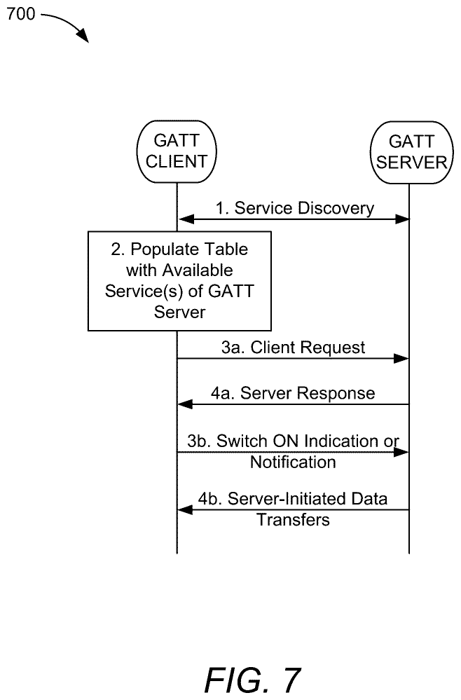

FIG. 7 illustrates an example BLE GATT procedure 700, according to aspects of the disclosure. At stage (1), a GATT client performs service discovery with a GATT server. At stage (2), the GATT client populates a table of available service(s) of the GATT server obtained from stage (1). At stage (3a), the GATT client transmits a client request to the GATT server. At stage (4a), the GATT server transmits a server response to the client request from stage (3a). As an alternative to (or in addition to) stages (3a) and (4a), at stage (3b), the GATT client may transmit a switch ON indication or notification to the GATT server, and at stage (4b), the GATT server may perform a server-initiated data transfer.

Another example wireless communications protocol that may be utilized to support electronic label-to-AP signaling is the electronic label periodic advertising with responses (PAWR) protocol. In electronic label PAWR, electronic labels can be sent a vendor-specific command via an advertising synchronization packet from the AP, and target device RSSI data can be reported by the electronic label in a specific advertisement slot period, electronic labels may be grouped and addressed as a group (via a group ID). An advantage to this approach is minimum overhead and quick response time. A downside to this approach is the advertisement packet payload size is limited (48 bytes), so only one target device payload (40 bytes) may fit in one slot. As such, multiple target devices' data may need multiple slots. Note that the duration of a frame may vary from as low as 1.6 seconds to as long as 16 seconds (based on configuration).

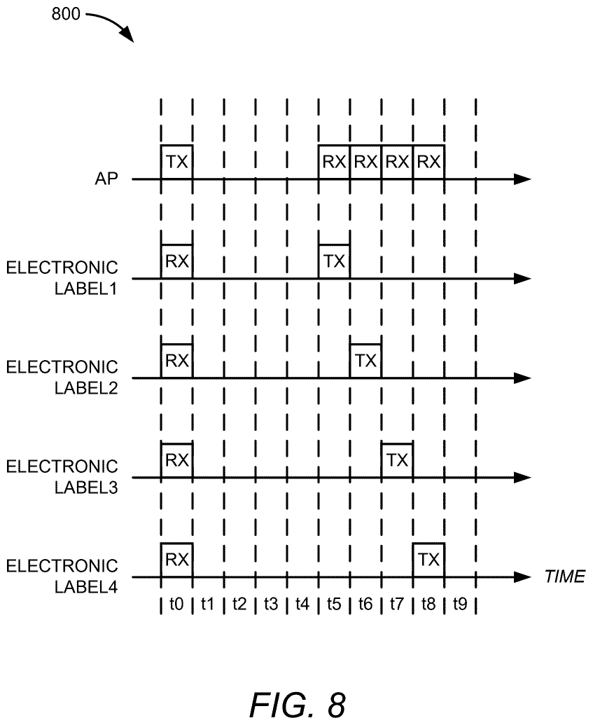

FIG. 8 illustrates an example electronic label PAWR scheme 800, according to aspects of the disclosure. The electronic label PAWR scheme 800 is described with respect to a cluster/group of electronic labels that includes four electronic labels, denoted as ELECTRONIC LABELs1-4. At slot to, the electronic label AP transmits scheduling information to ELECTRONIC LABELs1-4. Assuming that ELECTRONIC LABELs1-4 operate in electronic label radio scan mode (i.e., receive (Rx) mode) during slots t1-t4 (e.g., collecting electronic label measurement information), then ELECTRONIC LABELs1-4 each transmit measurement feedback collected during the electronic label radio scan mode to the electronic label AP during slots t5-t8. Note that each ELECTRONIC LABELs1-4 may only wake up once every frame to listen and respond. As will be appreciated, for highly populated clusters/groups of electronic labels, the measurement feedback to the electronic label AP can take a significant amount of time and incur high signaling and scheduling overhead.

Electronic labels are expected to be deployed in various places such as retails stores and warehouses such that product information can be displayed digitally and changed or updated immediately. In some aspects, the electronic label radio infrastructures may be repurposed and used for position estimation, since they present a highly-dense network of anchor nodes that can achieve a high degree of accuracy (e.g., sub-meter accuracy) in indoor venues such as shops, retail stores, or warehouses, albeit with constraints on power consumption (since they are battery powered).

In some aspects, electronic label radios may relay information transmitted by low-cost battery-less energy-harvesting ambient IoT tags (e.g., eTags), which are attached to products, packaging, and/or crates throughout the venue. In some aspects, eTag payloads may be encrypted by using asymmetric keys known only to the eTags (e.g., the sender) and the server or management entity (e.g., the receiver). In these implementations, intermediate devices such as electronic label radios and access points (Aps) merely relay the eTag payloads to the server.

However, in some scenarios, eTag packets may be associated with a large amount of security-related overhead, including a relatively large number of encryption bytes compared to the size of the data payload. For example, even if the data payload itself has only two bytes, the encrypted payload may have as many 40 bytes. In such scenarios, it may be advantageous to perform decryption at the edge, that is, decryption of the payload by the electronic label before the payload is relayed to the AP.

In some aspects, criteria may be provided for determining when to perform decryption of the eTag payload at the electronic label and the associated tradeoffs between decryption at the electronic label and decryption at the AP. In some aspects, schemes may be provided for enabling decryption at the electronic label (e.g., schemes for providing the private key to the electronic label, etc.). In some aspects, schemes may be provided for overhead reduction at the electronic label (e.g., in terms of reducing the overall packet size, number of transmissions to AP, etc.).

In some aspects, symmetric encryption may be regarded as an encryption scheme that uses a single key for both encryption and decryption of data. Since the same key is used to encrypt and to decrypt data, faster and less resource-intensive encryption may be achieved compared to asymmetric encryption, thereby improving the efficiency of the encryption operation.

In some aspects, symmetric encryption may require secure key exchange and management to ensure data protection. In the case of eTags, the secure key is hardwired or burnt into the hardware and/or firmware at the time of manufacture, thereby obviating the need for an over-the-air exchange of the encryption key. In some aspects, symmetric encryption may be used for encrypting large volumes of data, securing internal communications, and protecting data at rest. In some aspects, advantages of symmetric encryption may include simple and efficient operations as well as suitability for encrypting large amounts of data.

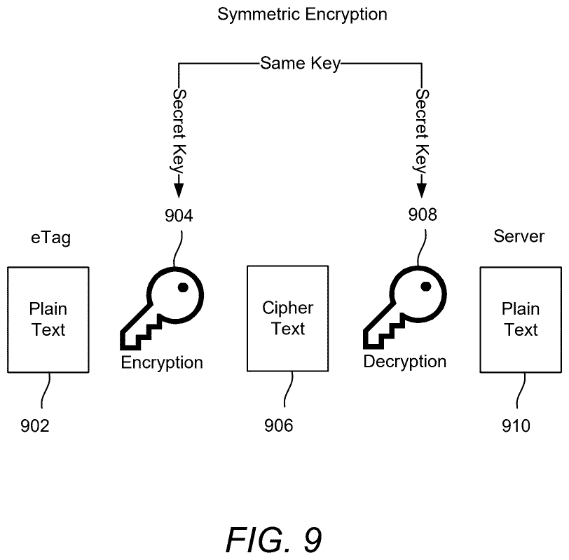

FIG. 9 illustrates example aspects of symmetric encryption, according to aspects of the disclosure. In the example illustrated in FIG. 9, a plain text 902 may be encrypted with an encryption key 904 at the eTag to generate a cipher text 906. The cipher text 906 may then be decrypted with a decryption key 908, which is the same as the encryption key 904, and converted back to the plain text 910 at the server. With symmetric encryption, the same key is used for both encryption and decryption.

In some aspects, decryption operations may be enabled at relay nodes such as electronic labels. In some existing implementations, intermediate entities may forward an encrypted payload to a network entity, such as a management entity (ME) on a server, which decrypts that encrypted payload. In some aspects, decryption of the payload may be performed at an intermediate entity (e.g., an electronic label or an AP) to reduce the encryption overhead, thereby increasing the efficiency of encryption and decryption operations.

In some aspects, overhead reduction with edge-entity decryption may be achieved in various manners. In a first implementation, an eTag may use an encryption security key selected from a set of security keys, and the selected security key may be uniquely identified by a key identifier (referred to as “key id”). In some aspects, the eTag may include the key id in its payload (unencrypted), and the decrypting entity (e.g., a network entity such as an ME) may have the mapping of the key id to the actual eTag security key.

In a second implementation, once an eTag appears in a venue (e.g., a retail store or a warehouse), and an initial beacon transmitted by the eTag is received by the ME, then the corresponding eTag security key may be delivered by the ME to one or more electronic label radios. One or more electronic labels may then decrypt the received beacon and transmit only the decrypted data back to the ME. In some implementations, the key may be delivered to an electronic label radio over a secure link, such as a GATT protocol link. In some implementations, the key may be delivered to one or more electronic labels in the vicinity of the eTag.

In a third implementation, a relatively small number or subset of keys may be stored in an electronic label itself (e.g., a read-only memory (ROM)). If the key id (sent by the eTag) matches one of the keys stored in the electronic label, it may perform decryption of the received encrypted payload. In some aspects, this key storage may be a one-time event at the time of manufacture or deployment of the electronic label, in which the subset of stored keys may correspond to eTags that are considered highly important (e.g., certain eTags that are considered important in a retail or warehouse environment). For example, certain eTags may be attached to valuable or relatively expensive items such as electronic devices in a retail or warehouse environment.

In some aspects, a subset of stored keys may be updated dynamically. For example, the AP may deliver and update the subset of keys stored at a given electronic label. In some aspects, this subset of keys may include only those keys being used by eTags in the vicinity of the electronic label. For example, the eTags attached to a range of products in a given aisle may use a certain subset of keys, and the same subset of keys may be provided to the electronic labels in that aisle. In some aspects, the key update may occur when a new set of eTags and their associated keys are introduced in the vicinity of the electronic label.

In some aspects, an electronic label may perform decryption based on one or more criteria that reflect tradeoffs between various competing demands, for example, between power consumption and processing complexity or cost associated with decryption and/or radio transmission. In some aspects, parameters such as the packet size of the encrypted eTag payload, the link budget with the AP, and processing or computation complexity or cost associated with encryption, may affect the decision on whether to assign the electronic label the task of performing decryption.

In some aspects, the decision of whether to perform decryption at the electronic label may depend at least in part on the size of the encrypted payload. If the encrypted eTag payload has a large size, then the performance gains resulting from decryption by the electronic label and discarding the associated encryption overhead may be minimal. In such a scenario, the electronic label may choose to simply relay the eTag packet to the AP without decryption if the encrypted eTag payload size is at or above a threshold value.

In some aspects, the decision of whether to perform decryption at the electronic label may depend at least in part on the link budget of the electronic label with the AP. Some electronic label radios may be located far away from an AP (e.g., near the edge of coverage area of the AP) and thus may require greater transmit power. On the other hand, electronic label radios that are relatively close to the AP may require less transmit power.

If the electronic label is far away from the AP, then it may be beneficial to prioritize decryption which results in smaller (decrypted) packets to be relayed. When smaller packets are delivered over the air, less transmit power may be required, thus resulting in less power consumption on the part of the electronic label. Conversely, if the electronic label radio is relatively close to the AP, then it may relay an eTag packet without decryption at relatively low transmit power, even though the eTag packet may have a relatively large size before decryption and thus incur a relatively long transmit duration. In some aspects, the determination of whether to perform decryption at the electronic label may be based at least in part on whether the distance between the electronic label and the AP is above or below a threshold distance.

In some aspects, the decision of whether to perform decryption at the electronic label may depend at least in part on the computation or processing complexity or cost associated with encryption. For example, the computation or processing complexity or cost associated with AES-256 is higher than that associated with AES-128 (where AES stands for Advanced Encryption Standard).

In some aspects, the electronic label may calculate, estimate, or optimize the overall tradeoff between various competing demands. For example, the electronic label may determine whether the benefit of a decrease in the transmit duration/power associated with reduced overhead for relaying a smaller (decrypted) packet would outweigh an increase in the processing complexity or cost of decryption at the electronic label, or vice versa.

In some implementations, high-level tradeoff policies may be configured by the ME (e.g., via the electronic label and/or AP), whereas lower-level tradeoff policies (or finer variations) may be decided by the individual electronic label. For example, an electronic label may change the threshold for determining whether a received (encrypted) eTag packet size would warrant a decryption operation by the electronic label. If the electronic label is running low on battery, it may prioritize power conservation over lower latency or faster speed of relaying the packet.

In some aspects, after the relay node (e.g., electronic label or AP) decrypts the received (encrypted) payload, it can see the decrypted data and determine at least some of the characteristics associated with the decrypted data. In some aspects, the electronic label and/or AP may decide to relay only certain types of payloads, for example, high-priority payloads or payloads associated with high-priority tags.

In some aspects, the priority level of the received payload may be inferred from the content of the decrypted an eTag packet. For example, in some scenarios, an eTag may have sent weight sensor information which may not be regarded as high-priority information for the server (e.g., an ME), or it may have sent a sensor measurement that is below a threshold value (e.g., when the weight of a product is below a threshold value). In some aspects, the condition(s) for determining such priority level(s) may be transmitted by an AP to an electronic label.

In some scenarios, upon determining that a received eTag payload is a low-priority payload, the electronic label and/or AP may send an indication to the server (e.g., an ME) that it has received a beacon from an eTag but is not relaying the associated payload. In some scenarios, the duty cycle of relaying such low-priority payloads to the AP may be reduced, thereby reducing power consumption on the part of the electronic label. For example, in some implementations, the electronic label may send every n^{th} payload to the AP.

In some scenarios, the electronic label may trim one or more portions of an eTag payload. For example, the prefix bits associated with the MAC of an eTag payload may be discarded. In some instances, an entire eTag payload may be discarded if it is deemed unimportant or low-priority. In some scenarios, an eTag payload may be relayed by a UE if the UE has the security key. In some scenarios, the ME may distribute a security key to a UE that is co-located with the eTag in a secure manner. In some scenarios, the UE may provide decryption keys to authorized handheld devices operated by store or warehouse employees, for example.

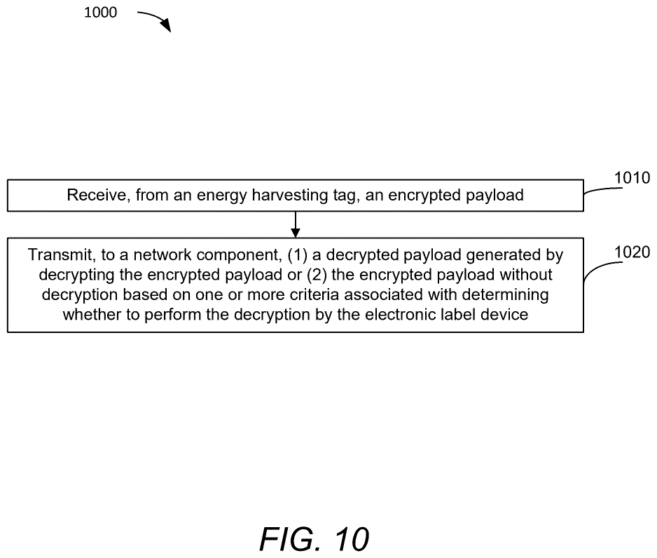

FIG. 10 illustrates an example method 1000 of wireless payload decryption, according to aspects of the disclosure. In some aspects, method 1000 may be performed by an electronic label device (e.g., any of the UEs, base stations, or base station components described herein).

At operation 1010, the electronic label device may receive, from an energy harvesting tag, an encrypted payload.

In some aspects, operation 1010 may be performed by the IR sensor, LNA, radio, MCU, and/or the like illustrated in FIG. 2, any or all of which may be considered means for performing this operation.

At operation 1020, the electronic label device may transmit, to a network component, (1) a decrypted payload generated by decrypting the encrypted payload or (2) the encrypted payload without decryption based on one or more criteria associated with determining whether to perform the decryption by the electronic label device.

In some aspects, operation 1020 may be performed by the IR sensor, LNA, radio, MCU, and/or the like illustrated in FIG. 2, any or all of which may be considered means for performing this operation.

As will be appreciated, a technical advantage of the method 1000 is that, by allowing the electronic label device (e.g., electronic label) to determine whether to decrypt an encrypted eTag payload or to relay the encrypted payload to the network component (e.g., AP) without decryption, the payload (encrypted or decrypted) may be transferred efficiently by balancing the tradeoffs between power consumption and complexity of decryption processing on the part of the electronic label device, based on factors such as the size of the encrypted payload, the distance between the electronic label and the AP, the computation or processing cost associated with decryption, energy storage at the electronic label, the priority of the eTag, and/or the priority of the payload.

Implementation examples are described in the following numbered clauses:

Clause 1: A method performed by an electronic label device, comprising: receiving, from an energy harvesting tag, an encrypted payload; and transmitting, to a network component, (1) a decrypted payload generated by decrypting the encrypted payload or (2) the encrypted payload without decryption based on one or more criteria associated with determining whether to perform the decryption by the electronic label device.

Clause 2: The method of clause 1, wherein the encrypted payload comprises a key identifier associated with a security key.

Clause 3: The method of any of clauses 1 to 2, wherein the key identifier is unencrypted.

Clause 4: The method of any of clauses 1 to 3, further comprising: receiving, from the network component, a plurality of security keys; and decrypting the encrypted payload with a matched security key determined by matching the key identifier with a security key among the plurality of security keys.

Clause 5: The method of any of clauses 1 to 4, wherein the encrypted payload is carried by a beacon transmitted by the energy harvesting tag.

Clause 6: The method of any of clauses 1 to 5, further comprising: receiving, from the network component, a security key associated with the beacon; decrypting the beacon with the security key; and transmitting, to the network component, data in the decrypted payload.

Clause 7: The method of any of clauses 1 to 6, wherein the security key is received over a generic attribute profile (GATT) protocol link.

Clause 8: The method of any of clauses 1 to 7, wherein a subset of security keys is stored in the electronic label device.

Clause 9: The method of any of clauses 1 to 8, further comprising: decrypting the encrypted payload with a matched security key determined by matching a key identifier in the encrypted payload with a security key among the subset of security keys.

Clause 10: The method of any of clauses 1 to 9, wherein the subset of security keys is updated dynamically by the network component.

Clause 11: The method of any of clauses 1 to 10, wherein the one or more criteria comprise a criterion based on a size of the encrypted payload, further comprising: decrypting the encrypted payload based on a determination that the size of the encrypted payload is below a threshold size.

Clause 12: The method of any of clauses 1 to 11, further comprising: transmitting, to the network component, the encrypted payload without decryption based on a determination that that the size of the encrypted payload is at or above the threshold size.

Clause 13: The method of any of clauses 1 to 12, wherein the one or more criteria comprise a criterion based on a distance between the electronic label device and an access point (AP), further comprising: decrypting the encrypted payload based on a determination that the distance between the electronic label device and the AP is at or above a threshold distance.

Clause 14: The method of any of clauses 1 to 13, further comprising: transmitting, to the network component, the encrypted payload without decryption based on a determination that the distance between the electronic label device and the AP is below the threshold distance.

Clause 15: The method of any of clauses 1 to 14, wherein the one or more criteria comprise a criterion based on decryption processing complexity, further comprising: determining whether to (1) decrypt the encrypted payload or (2) transmit the encrypted payload to the network component without decryption based on the decryption processing complexity.

Clause 16: The method of any of clauses 1 to 15, further comprising: determining whether to (1) decrypt the encrypted payload or (2) transmit the encrypted payload to the network component without decryption based on an energy storage of the electronic label device.

Clause 17: The method of any of clauses 1 to 16, further comprising: determining whether to transmit, to the network component, an entirety of the decrypted payload, a portion of the decrypted payload, or no portion of the decrypted payload based on a priority of the energy harvesting tag or a priority of the encrypted payload.

Clause 18: The method of any of clauses 1 to 17, wherein the network component is an access point (AP), a server, or a management entity (ME).

Clause 19: An electronic label device, comprising: one or more memories; one or more transceivers; and one or more processors communicatively coupled to the one or more memories and the one or more transceivers, the one or more processors, either alone or in combination, configured to: receive, via the one or more transceivers, from an energy harvesting tag, an encrypted payload; and transmit, via the one or more transceivers, to a network component, (1) a decrypted payload generated by decrypting the encrypted payload or (2) the encrypted payload without decryption based on one or more criteria associated with determining whether to perform the decryption by the electronic label device.

Clause 20: The electronic label device of clause 19, wherein the encrypted payload comprises a key identifier associated with a security key.

Clause 21: The electronic label device of any of clauses 19 to 20, wherein the key identifier is unencrypted.

Clause 22: The electronic label device of any of clauses 19 to 21, wherein the one or more processors, either alone or in combination, are further configured to: receive, via the one or more transceivers, from the network component, a plurality of security keys; and decrypt the encrypted payload with a matched security key determined by matching the key identifier with a security key among the plurality of security keys.

Clause 23: The electronic label device of any of clauses 19 to 22, wherein the encrypted payload is carried by a beacon transmitted by the energy harvesting tag.

Clause 24: The electronic label device of any of clauses 19 to 23, wherein the one or more processors, either alone or in combination, are further configured to: receive, via the one or more transceivers, from the network component, a security key associated with the beacon; decrypt the beacon with the security key; and transmit, via the one or more transceivers, to the network component, data in the decrypted payload.

Clause 25: The electronic label device of any of clauses 19 to 24, wherein the security key is received over a generic attribute profile (GATT) protocol link.

Clause 26: The electronic label device of any of clauses 19 to 25, wherein a subset of security keys is stored in the electronic label device.

Clause 27: The electronic label device of any of clauses 19 to 26, wherein the one or more processors, either alone or in combination, are further configured to: decrypt the encrypted payload with a matched security key determined by matching a key identifier in the encrypted payload with a security key among the subset of security keys.

Clause 28: The electronic label device of any of clauses 19 to 27, wherein the subset of security keys is updated dynamically by the network component.

Clause 29: The electronic label device of any of clauses 19 to 28, wherein the one or more criteria comprise a criterion based on a size of the encrypted payload, and the one or more processors, either alone or in combination, are further configured to: decrypt the encrypted payload based on a determination that the size of the encrypted payload is below a threshold size.

Clause 30: The electronic label device of any of clauses 19 to 29, wherein the one or more processors, either alone or in combination, are further configured to: transmit, via the one or more transceivers, to the network component, the encrypted payload without decryption based on a determination that that the size of the encrypted payload is at or above the threshold size.

Clause 31: The electronic label device of any of clauses 19 to 30, wherein the one or more criteria comprise a criterion based on a distance between the electronic label device and an access point (AP), and the one or more processors, either alone or in combination, are further configured to: decrypt the encrypted payload based on a determination that the distance between the electronic label device and the AP is at or above a threshold distance.

Clause 32: The electronic label device of any of clauses 19 to 31, wherein the one or more processors, either alone or in combination, are further configured to: transmit, via the one or more transceivers, to the network component, the encrypted payload without decryption based on a determination that the distance between the electronic label device and the AP is below the threshold distance.

Clause 33: The electronic label device of any of clauses 19 to 32, wherein the one or more criteria comprise a criterion based on decryption processing complexity, and the one or more processors, either alone or in combination, are further configured to: determine whether to (1) decrypt the encrypted payload or (2) transmit the encrypted payload to the network component without decryption based on the decryption processing complexity.

Clause 34: The electronic label device of any of clauses 19 to 33, wherein the one or more processors, either alone or in combination, are further configured to: determine whether to (1) decrypt the encrypted payload or (2) transmit the encrypted payload to the network component without decryption based on an energy storage of the electronic label device.

Clause 35: The electronic label device of any of clauses 19 to 34, wherein the one or more processors, either alone or in combination, are further configured to: determine whether to transmit, to the network component, an entirety of the decrypted payload, a portion of the decrypted payload, or no portion of the decrypted payload based on a priority of the energy harvesting tag or a priority of the encrypted payload.

Clause 36: The electronic label device of any of clauses 19 to 35, wherein the network component is an access point (AP), a server, or a management entity (ME).

Clause 37: An electronic label device, comprising: means for receiving, from an energy harvesting tag, an encrypted payload; and means for transmitting, to a network component, (1) a decrypted payload generated by decrypting the encrypted payload or (2) the encrypted payload without decryption based on one or more criteria associated with determining whether to perform the decryption by the electronic label device.

Clause 38: The electronic label device of clause 37, wherein the encrypted payload comprises a key identifier associated with a security key.

Clause 39: The electronic label device of any of clauses 37 to 38, wherein the key identifier is unencrypted.

Clause 40: The electronic label device of any of clauses 37 to 39, further comprising: means for receiving, from the network component, a plurality of security keys; and means for decrypting the encrypted payload with a matched security key determined by matching the key identifier with a security key among the plurality of security keys.

Clause 41: The electronic label device of any of clauses 37 to 40, wherein the encrypted payload is carried by a beacon transmitted by the energy harvesting tag.

Clause 42: The electronic label device of any of clauses 37 to 41, further comprising: means for receiving, from the network component, a security key associated with the beacon; means for decrypting the beacon with the security key; and means for transmitting, to the network component, data in the decrypted payload.

Clause 43: The electronic label device of any of clauses 37 to 42, wherein the security key is received over a generic attribute profile (GATT) protocol link.

Clause 44: The electronic label device of any of clauses 37 to 43, wherein a subset of security keys is stored in the electronic label device.

Clause 45: The electronic label device of any of clauses 37 to 44, further comprising: means for decrypting the encrypted payload with a matched security key determined by matching a key identifier in the encrypted payload with a security key among the subset of security keys.

Clause 46: The electronic label device of any of clauses 37 to 45, wherein the subset of security keys is updated dynamically by the network component.

Clause 47: The electronic label device of any of clauses 37 to 46, wherein the one or more criteria comprise a criterion based on a size of the encrypted payload, further comprising: means for decrypting the encrypted payload based on a determination that the size of the encrypted payload is below a threshold size.

Clause 48: The electronic label device of any of clauses 37 to 47, further comprising: means for transmitting, to the network component, the encrypted payload without decryption based on a determination that that the size of the encrypted payload is at or above the threshold size.

Clause 49: The electronic label device of any of clauses 37 to 48, wherein the one or more criteria comprise a criterion based on a distance between the electronic label device and an access point (AP), further comprising: means for decrypting the encrypted payload based on a determination that the distance between the electronic label device and the AP is at or above a threshold distance.

Clause 50: The electronic label device of any of clauses 37 to 49, further comprising: means for transmitting, to the network component, the encrypted payload without decryption based on a determination that the distance between the electronic label device and the AP is below the threshold distance.

Clause 51: The electronic label device of any of clauses 37 to 50, wherein the one or more criteria comprise a criterion based on decryption processing complexity, further comprising: means for determining whether to (1) decrypt the encrypted payload or (2) transmit the encrypted payload to the network component without decryption based on the decryption processing complexity.

Clause 52: The electronic label device of any of clauses 37 to 51, further comprising: means for determining whether to (1) decrypt the encrypted payload or (2) transmit the encrypted payload to the network component without decryption based on an energy storage of the electronic label device.

Clause 53: The electronic label device of any of clauses 37 to 52, further comprising: means for determining whether to transmit, to the network component, an entirety of the decrypted payload, a portion of the decrypted payload, or no portion of the decrypted payload based on a priority of the energy harvesting tag or a priority of the encrypted payload.

Clause 54: The electronic label device of any of clauses 37 to 53, wherein the network component is an access point (AP), a server, or a management entity (ME).

Clause 55: A non-transitory computer-readable medium storing computer-executable instructions that, when executed by an electronic label device, cause the electronic label device to: receive, from an energy harvesting tag, an encrypted payload; and transmit, to a network component, (1) a decrypted payload generated by decrypting the encrypted payload or (2) the encrypted payload without decryption based on one or more criteria associated with determining whether to perform the decryption by the electronic label device.

Clause 56: The non-transitory computer-readable medium of clause 55, wherein the encrypted payload comprises a key identifier associated with a security key.

Clause 57: The non-transitory computer-readable medium of any of clauses 55 to 56, wherein the key identifier is unencrypted.

Clause 58: The non-transitory computer-readable medium of any of clauses 55 to 57, further comprising computer-executable instructions that, when executed by the electronic label device, cause the electronic label device to: receive, from the network component, a plurality of security keys; and decrypt the encrypted payload with a matched security key determined by matching the key identifier with a security key among the plurality of security keys.

Clause 59: The non-transitory computer-readable medium of any of clauses 55 to 58, wherein the encrypted payload is carried by a beacon transmitted by the energy harvesting tag.

Clause 60: The non-transitory computer-readable medium of any of clauses 55 to 59, further comprising computer-executable instructions that, when executed by the electronic label device, cause the electronic label device to: receive, from the network component, a security key associated with the beacon; decrypt the beacon with the security key; and transmit, to the network component, data in the decrypted payload.

Clause 61: The non-transitory computer-readable medium of any of clauses 55 to 60, wherein the security key is received over a generic attribute profile (GATT) protocol link.

Clause 62: The non-transitory computer-readable medium of any of clauses 55 to 61, wherein a subset of security keys is stored in the electronic label device.

Clause 63: The non-transitory computer-readable medium of any of clauses 55 to 62, further comprising computer-executable instructions that, when executed by the electronic label device, cause the electronic label device to: decrypt the encrypted payload with a matched security key determined by matching a key identifier in the encrypted payload with a security key among the subset of security keys.

Clause 64: The non-transitory computer-readable medium of any of clauses 55 to 63, wherein the subset of security keys is updated dynamically by the network component.

Clause 65: The non-transitory computer-readable medium of any of clauses 55 to 64, wherein the one or more criteria comprise a criterion based on a size of the encrypted payload, further comprising computer-executable instructions that, when executed by the electronic label device, cause the electronic label device to: decrypt the encrypted payload based on a determination that the size of the encrypted payload is below a threshold size.

Clause 66: The non-transitory computer-readable medium of any of clauses 55 to 65, further comprising computer-executable instructions that, when executed by the electronic label device, cause the electronic label device to: transmit, to the network component, the encrypted payload without decryption based on a determination that that the size of the encrypted payload is at or above the threshold size.

Clause 67: The non-transitory computer-readable medium of any of clauses 55 to 66, wherein the one or more criteria comprise a criterion based on a distance between the electronic label device and an access point (AP), further comprising computer-executable instructions that, when executed by the electronic label device, cause the electronic label device to: decrypt the encrypted payload based on a determination that the distance between the electronic label device and the AP is at or above a threshold distance.

Clause 68: The non-transitory computer-readable medium of any of clauses 55 to 67, further comprising computer-executable instructions that, when executed by the electronic label device, cause the electronic label device to: transmit, to the network component, the encrypted payload without decryption based on a determination that the distance between the electronic label device and the AP is below the threshold distance.

Clause 69: The non-transitory computer-readable medium of any of clauses 55 to 68, wherein the one or more criteria comprise a criterion based on decryption processing complexity, further comprising computer-executable instructions that, when executed by the electronic label device, cause the electronic label device to: determine whether to (1) decrypt the encrypted payload or (2) transmit the encrypted payload to the network component without decryption based on the decryption processing complexity.

Clause 70: The non-transitory computer-readable medium of any of clauses 55 to 69, further comprising computer-executable instructions that, when executed by the electronic label device, cause the electronic label device to: determine whether to (1) decrypt the encrypted payload or (2) transmit the encrypted payload to the network component without decryption based on an energy storage of the electronic label device.

Clause 71: The non-transitory computer-readable medium of any of clauses 55 to 70, further comprising computer-executable instructions that, when executed by the electronic label device, cause the electronic label device to: determine whether to transmit, to the network component, an entirety of the decrypted payload, a portion of the decrypted payload, or no portion of the decrypted payload based on a priority of the energy harvesting tag or a priority of the encrypted payload.

Clause 72: The non-transitory computer-readable medium of any of clauses 55 to 71, wherein the network component is an access point (AP), a server, or a management entity (ME).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An electronic label device, comprising:
one or more memories;
one or more transceivers; and
one or more processors communicatively coupled to the one or more memories and the one or more transceivers, the one or more processors, either alone or in combination, configured to:
receive, via the one or more transceivers, from an energy harvesting tag, an encrypted payload; and
transmit, via the one or more transceivers, to a network component, (1) a decrypted payload generated by decrypting the encrypted payload or (2) the encrypted payload without decryption based on one or more criteria associated with determining whether to perform the decryption by the electronic label device.

2. The electronic label device of claim 1, wherein the encrypted payload comprises a key identifier associated with a security key.

3. The electronic label device of claim 2, wherein the key identifier is unencrypted.

4. The electronic label device of claim 2, wherein the one or more processors, either alone or in combination, are further configured to:
receive, via the one or more transceivers, from the network component, a plurality of security keys; and
decrypt the encrypted payload with a matched security key determined by matching the key identifier with a security key among the plurality of security keys.

5. The electronic label device of claim 1, wherein the encrypted payload is carried by a beacon transmitted by the energy harvesting tag.

6. The electronic label device of claim 5, wherein the one or more processors, either alone or in combination, are further configured to:
receive, via the one or more transceivers, from the network component, a security key associated with the beacon;
decrypt the beacon with the security key; and
transmit, via the one or more transceivers, to the network component, data in the decrypted payload.

7. The electronic label device of claim 6, wherein the security key is received over a generic attribute profile (GATT) protocol link.

8. The electronic label device of claim 1, wherein a subset of security keys is stored in the electronic label device.

9. The electronic label device of claim 8, wherein the one or more processors, either alone or in combination, are further configured to:
decrypt the encrypted payload with a matched security key determined by matching a key identifier in the encrypted payload with a security key among the subset of security keys.

10. The electronic label device of claim 8, wherein the subset of security keys is updated dynamically by the network component.

11. The electronic label device of claim 1, wherein the one or more criteria comprise a criterion based on a size of the encrypted payload, and the one or more processors, either alone or in combination, are further configured to:
decrypt the encrypted payload based on a determination that the size of the encrypted payload is below a threshold size.

12. The electronic label device of claim 11, wherein the one or more processors, either alone or in combination, are further configured to:
transmit, via the one or more transceivers, to the network component, the encrypted payload without decryption based on a determination that that the size of the encrypted payload is at or above the threshold size.

13. The electronic label device of claim 1, wherein the one or more criteria comprise a criterion based on a distance between the electronic label device and an access point (AP), and the one or more processors, either alone or in combination, are further configured to:
decrypt the encrypted payload based on a determination that the distance between the electronic label device and the AP is at or above a threshold distance.

14. The electronic label device of claim 13, wherein the one or more processors, either alone or in combination, are further configured to:
transmit, via the one or more transceivers, to the network component, the encrypted payload without decryption based on a determination that the distance between the electronic label device and the AP is below the threshold distance.

15. The electronic label device of claim 1, wherein the one or more criteria comprise a criterion based on decryption processing complexity, and the one or more processors, either alone or in combination, are further configured to:
determine whether to (1) decrypt the encrypted payload or (2) transmit the encrypted payload to the network component without decryption based on the decryption processing complexity.

16. The electronic label device of claim 1, wherein the one or more processors, either alone or in combination, are further configured to:
determine whether to (1) decrypt the encrypted payload or (2) transmit the encrypted payload to the network component without decryption based on an energy storage of the electronic label device.

17. The electronic label device of claim 1, wherein the one or more processors, either alone or in combination, are further configured to:
determine whether to transmit, to the network component, an entirety of the decrypted payload, a portion of the decrypted payload, or no portion of the decrypted payload based on a priority of the energy harvesting tag or a priority of the encrypted payload.

18. The electronic label device of claim 1, wherein the network component is an access point (AP), a server, or a management entity (ME).

19. A method performed by an electronic label device, comprising:
receiving, from an energy harvesting tag, an encrypted payload; and
transmitting, to a network component, (1) a decrypted payload generated by decrypting the encrypted payload or (2) the encrypted payload without decryption based on one or more criteria associated with determining whether to perform the decryption by the electronic label device.

20. An electronic label device, comprising:
means for receiving, from an energy harvesting tag, an encrypted payload; and
means for transmitting, to a network component, (1) a decrypted payload generated by decrypting the encrypted payload or (2) the encrypted payload without decryption based on one or more criteria associated with determining whether to perform the decryption by the electronic label device.
